(19) United States
(12) Patent Application Publication
(10) Pub. No.: US 2009/0115729 A1
(43) Pub. Date: May 7, 2009

(54) CURSOR CONTROL DEVICE FOR AVIONICS DISPLAYS

(75) Inventors: Gregory M. Groener, Prairie Village, KS (US); James E. Brockman, Kansas City, MO (US)

Correspondence Address: GARMIN INTERNATIONAL, INC.;ATTN: Legal - IP, 1200 EAST 151ST STREET, OLATHE, KS, 66062, US

(73) Assignee: GARMIN INTERNATIONAL, INC., Olathe, KS (US)

(21) Appl. No.: 11/933,525

(22) Filed: Nov. 1, 2007

(51) Int. Cl. G06F 3/033

(52) U.S. Cl. 345/167

(57) ABSTRACT

A device for controlling a cursor on an avionics display screen. The device has a grab handle conveniently located and shaped to be comfortably gripped. The handle is equipped with a trackball which can be turned by the thumb to move the cursor on the display. Alternatively or additionally, a trigger may be provided to effect a select function using the index finger. One or more switches may be provided on the handle to change the content on the display.

### BACKGROUND

1. Field

Embodiments of the present invention relate generally to the display of avionic information and more particularly to a device used for controlling a cursor on an avionics display.

2. Description of the Related Art

Aircraft are often equipped with one or more display screens containing a variety of flight related information, including data from instrumentation, navigation, weather conditions, terrain, air traffic in the vicinity, engine settings and conditions, and other data and visual material. Typically, pilots or co-pilots control the functionality and content provided by the display screens by functioning keys associated with the screens or by touching the screens if they are configured as touchscreens.

### SUMMARY

Embodiments of the present invention are directed to a control device that may be used to control a cursor location on an avionics display and to make selections based on the cursor position. In accordance with one embodiment of the invention, a grab handle is provided on the housing of the control device that presents a shape operable to be comfortably gripped by a pilot or co-pilot seated in the cockpit. The handle may be equipped with a trackball at a location where the pilot's thumb can be conveniently used to manipulate the trackball in a manner to move the cursor in various directions on the display. In some embodiments, a selection can be made of an item on which the cursor is positioned by functioning a trigger associated with the handle or by depressing the trackball.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWING FIGURES

Various embodiments of the present invention are described in detail below with reference to the attached drawing figures, wherein:

FIG. 1 is a perspective view of a cursor control device constructed according to various embodiments of the present invention;

FIG. 2 is a top plan view on an enlarged scale of the cursor control device shown in FIG. 1;

FIG. 3 is a side elevational view of the cursor control device shown in FIGS. 1 and 2;

FIG. 4 is a perspective view of the cursor control device shown in FIGS. 1 through 3; and

FIG. 5 is an environmental view depicting a pair of the cursor control devices of FIGS. 1 through 4 installed in the cockpit of an aircraft.

The drawing figures do not limit the present invention to the specific embodiments disclosed and described herein. The drawings are not necessarily to scale, emphasis instead being placed upon clearly illustrating various embodiments of the invention.

### DETAILED DESCRIPTION

The following detailed description of various embodiments of the invention references the accompanying drawings which illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

Referring to the drawings in more detail, a cursor control device constructed according to various embodiments of the invention is generally identified by numeral 10. In some embodiments, the control device 10 may be coupled with or comprise a portion of an integrated avionics system 11, such as the Garmin® G1000® integrated flight system and/or the Garmin® GNS 530 panel mount system. However, the control device 10 may be utilized with any avionic equipment and display panels and is not limited to the exemplary systems discussed herein.

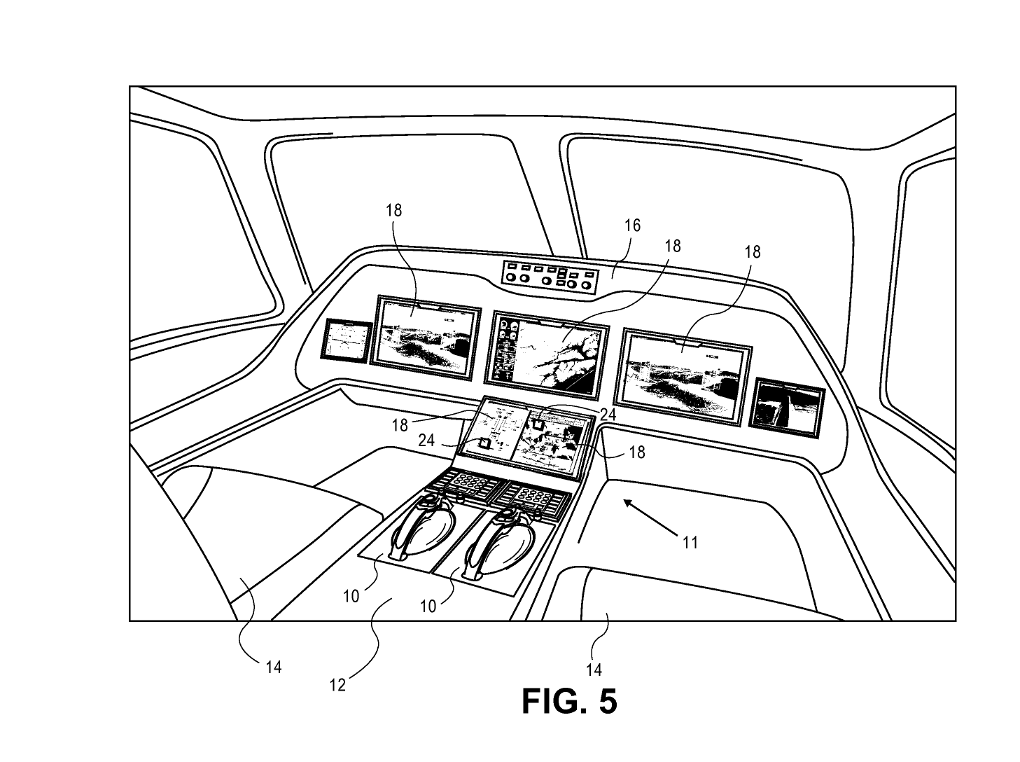

One or more of the control devices 10 may be installed on or within a center console 12 located in the cockpit of an aircraft. In some embodiments as illustrated in FIG. 5, the control devices 10 may be installed in a side-by-side configuration within the aircraft. The center console 12 is located between a pair of seats 14 in the cockpit which are typically occupied by a pilot and a co-pilot. A dashboard 16 in the cockpit located forwardly of the seats 14 may include various components of the integrated avionics system 11, such as one or more display screens 18 comprising primary and secondary flight display panels, multifunction displays, combinations thereof, and the like.

The display screens 18 may include various display elements, including thin-film transistor (TFT) displays, liquid crystal displays (LCD), light-emitting diode (LED) and organic light-emitting diode (OLED) displays, and cathode ray tube (CRT) monitors. The display screens 18 may be associated with the integrated avionics system 11 to present any flight-related information, including navigation, terrain, and map information, flight statistics and characteristics, weather information, radar information, air traffic information and traffic avoidance information, flight control and autopilot information, combinations thereof, and the like.

The integrated avionics system 11 may present a cursor 24 on one or more of the display screens 18 which is movable across, up and down, and/or over the one or more display screens 18 under the control of the device 10 in a manner that will be described. The cursor 24 may be utilized by the pilot and/or co-pilot to control the functionality of the integrated avionics system 11, such as by selecting information for display and/or providing control inputs to the integrated avionics system 11 for various functions. The integrated avionics system 11 may include any number of display screens 18 and is not limited to the exemplary configuration illustrated in FIG. 5.

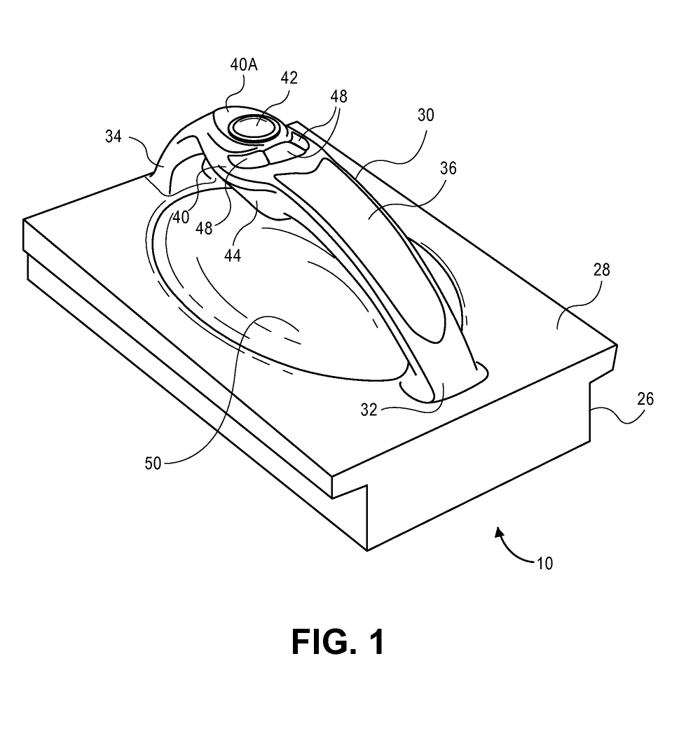

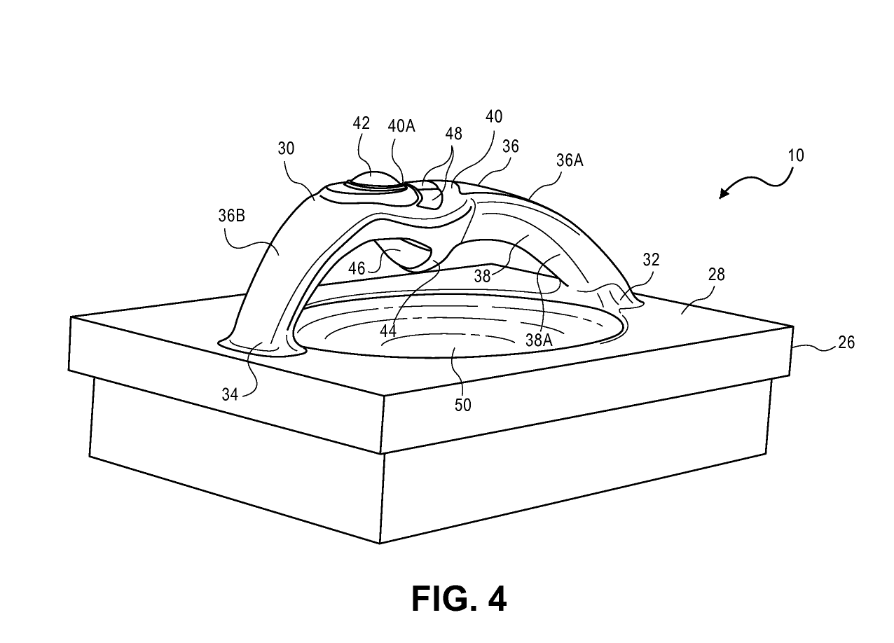

With particular reference to FIGS. 1 through 4, the control device 10 can include a housing 26 which may have a rectangular configuration with a substantially flat upper surface 28. The housing 26 is configured for mounting on or within the center console 12. In some embodiments, the housing 26 may present standardized dimensions to facilitate mounting on or within the center console 12 and be adapted to replace existing devices disposed within the center console 12, such as one or more flight management system (FMS) components or other avionic and control devices. Thus, control device 10 may be substituted for a pre-existing cockpit component and/or be initially installed within the center console 12 during manufacture of the aircraft. In some embodiments, the control device 10 may couple with the center console 12 through non-mounting methods, such as by removably attaching to portions of the center console 12. However, in some embodiments, the control device 10 is rigidly attached within, on, or to the center console 12 to ensure that it may be readily gripped during flight operations.

A grab handle 30 is mounted on the upper surface 28 of housing 26. The handle 30 has a configuration to be conveniently and comfortably gripped by a human hand such as the hand of the pilot or co-pilot. The handle 30 may be immobile and fixedly and rigidly mounted to the housing 26 to enable the pilot or co-pilot to readily function the control device 10 by gripping the handle 30. The handle 30 may have an arch shaped configuration with opposite ends 32 and 34 connected with surface 28 near its opposite ends 32, 34. Handle 30 has an upper surface 36 and a lower surface 38 which both may curve gradually between the opposite ends 32 and 34 of the handle 30.

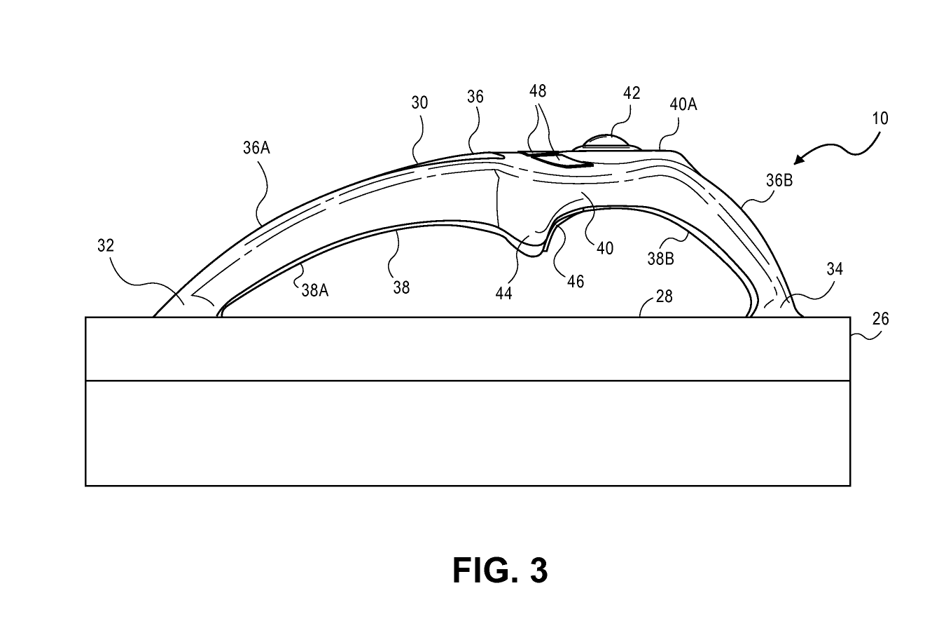

In some embodiments, as best shown in FIG. 3, the upper surface 36 has a portion 36a adjacent to end 32 that curves gradually toward a center portion 40 of the handle 30. The lower surface 38 of the handle likewise has a portion 38a that gradually curves from end 32 toward the center portion 40 of the handle 30. Portions 36b and 38b of the upper and lower surfaces 36 and 38, respectively, extend from end 34 of the handle to the center portion 40 and are shorter and oriented more vertically than portions 36a and 38a.

With continued reference to FIG. 3, the center portion 40 of handle 30 can have a generally flat upper surface 40a on which a trackball 42 having a spherical surface is mounted. The trackball 42 is mounted for rotation such that it can be turned by the pilot or co-pilot to provide signals for use by the integrated avionics system 11 to cause movement of the cursor 24. The trackball 42 may be turned to the right in order to move the cursor 24 to the right and turned to the left to move the cursor 24 to the left. Rotation of the trackball 42 in a direction away from end 32 of the handle may cause cursor 24 to move upwardly, while turning of cursor 24 in the opposite direction (toward end 32) may move the cursor downwardly. However, in some embodiments, the control device 10 and/or integrated avionics system 11 may be configured to move the cursor 24 in a direction different than that imparted to the trackball 42, such as where the trackball 42 is rotated downward to cause upward movement of the cursor 24.

The underside of the center portion 40 of handle 30 can extend downwardly to provide a thickened boss 44. A trigger 46 may be mounted on one side of the boss 44 at a location generally underlying the trackball 42. The trigger 46 may be depressed to provide one or more signals for use by the integrated avionic system 11 to carry out a “select” operation in which a selection is made of the item(s) on the display screen 18 over which the cursor 24 is currently positioned.

The trackball 42 can be mounted in a manner allowing it to be depressed as well as rotated. Depression of the trackball 42 is an alternative way in which the select operation can be effected. Thus, an item presented on the display screen 18 on which the cursor 24 is positioned may be selected either by depressing the trigger 46 and/or by depressing the trackball 42. In some embodiments of the invention, the select function may be effected only by depressing the trackball 42, only by depressing the trigger 46, or only by functioning both the trackball 42 and trigger 46.

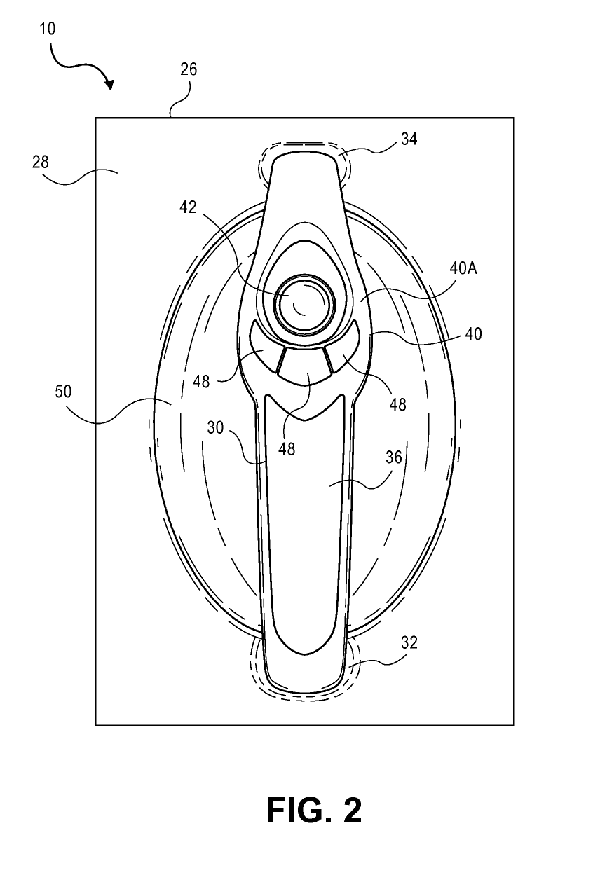

The content presented on each display screen 18 may be switched among various alternative options. Switching among different display content options may be carried out through the use of one or more switches 48 disposed on the handle 30. With reference to FIG. 2 in particular, three switches 48 may be provided, and they may be mounted on the upper surface 40a of center portion 40 of the handle 30 at a location near the trackball 42. The switches 48 may be mounted such that they can be depressed to effect the switching function for one or more of the display screens 18. Each of the switches 48 may be associated with a particular display option so that when a particular switch 48 is depressed, the material displayed by one of more of the display screens 18 is the material associated with that particular switch.

Each switch 48 may include any element or combination of elements operable to generate a signal for use by the integrated avionics system 11. For example, the switches 48 may include push-button switches, toggle switches, rocker switches, rotary switches, pressure-sensing switches, infrared, optical, magnetic, and electric field sensing switches, combinations thereof, and the like.

Immediately underlying the handle 30, the upper surface of housing 26 can be provided with a cavity or depression 50 which may be of any suitable shape including an elongated bowl shape having an oval perimeter with a curved lower surface. The handle 30 spans the depression 50 such that the depression 50 provides space for application of the hand of the pilot or co-pilot to the handle 30.

In use, the control device 10 may be installed in an aircraft cockpit in the center console 12 either alone or in a side by side arrangement with another device 10 as shown in FIG. 5. The device or devices 10 may be installed at a location conveniently accessible to the hand of a pilot or co-pilot seated on one of the seats 14. The device 10 may be installed with the handle 30 located forwardly or partially forwardly of the seat 14 and at a level where the hand of the pilot or co-pilot can conveniently reach and grip it.

The handle 30 may be shaped and arranged such that the hand can be applied with the fingers extending adjacent to surface 38a and the thumb applied to the trackball 42. The location of the trigger 46 makes it easily accessible to the index finger of a hand gripped onto the handle 30. However, the pilot or co-pilot may use any parts of their hands to function the trackball 42 and trigger 46. For example, the handle 30 may be gripped in a manner where the trackball 42 is functioned by the pilot's finger(s) and the trigger 46 is functioned by the pilot's thumb. The trackball 42 may be disposed on the upper surface 36 of the handle 30, while the trigger 46 may be disposed on the lower surface 38 of the handle 30, to provide easy access to the trackball 42 and trigger 46 regardless of how the pilot or co-pilot grip the handle 30.

The thumb may be applied to trackball 42 to turn it as desired in order to control the position of the cursor 24 on one or more of the display screens 18. When the cursor is positioned on an item that is to be selected by the select function, the item may be selected by depressing the trigger 46 with the index finger, by depressing the trackball 42 using the thumb, or by depressing both the trigger 46 and trackball 42. The content of one or more of the display screens 18 can be switched by depressing whichever of the switches 48 is associated with material desired to be displayed. The switches 48 may be located conveniently such that they can be depressed with the thumb or any of the fingers.

The switches 48 can also enable the pilot or co-pilot to quickly indicate which of the display screens 18 should be controlled by the control device 10. For example, each of the display screens 18 may be operable to simultaneously or alternatively present a cursor and the switches 48 may be functioned to indicate which of the cursors are controlled by the control device 10. In embodiments where the pair of control devices 10 is used, each of the control devices 10 may be configured to control the cursor on a different one of the display screens 18 using the switches 48.

Further, each of the control devices 10 could be used to control different cursors existing on the same or different display screens 18. For example, the pilot could be assigned a first cursor for control with a first one of the control devices 10 and the co-pilot could be assigned a second cursor for control with a second one of the control devices 10. Such a configuration enables the pilots to simultaneously control two cursors using the control devices 10. The pilot and co-pilot cursors may present different shapes or colors to allow rapid and easy identification. Further, the integrated avionics system 11 may present a single cursor that can move across and between each of the display screens 18 such that the trackball 42 may be functioned to move the cursor 24 between and across each of the display screens 18.

In this manner, the control device provides convenient control of the operation of the cursor 24 and the select function. The operation of the control device 10 can be quickly and easily carried out without undue distraction and without requiring unusual motions, strained movements, or awkward reaching.

It is believed that embodiments of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A control device for an avionics display mounted within an aircraft and presenting a movable cursor, the control device comprising:
a housing operable to be coupled with a center console of the aircraft;
a handle on the housing arranged to be gripped by a human hand having a thumb and a plurality of fingers; and
a rotatable trackball situated on the handle at a location to be turned by the thumb of the human hand gripped on the handle.

2. The device of claim 1, further including a trigger situated on the handle at a location to be depressed by one of the fingers of the human hand gripped on the handle.

3. The device of claim 2, wherein the handle has upper and lower surfaces, the trackball is situated on the upper surface, and the trigger is situated on the lower surface.

4. The device of claim 3, further including at least one switch situated on the upper surface.

5. The device of claim 1, wherein the handle is fixedly attached to the housing.

6. The device of claim 1, wherein—
the trackball is depressible,
the control device further includes a trigger situated on the handle at a location to be depressed by one of the fingers of the human hand gripped on the handle.

7. The device of claim 1, the handle presenting a generally arched configuration.

8. A control device for an avionics display mounted within an aircraft and presenting a movable cursor, the control device comprising:
a housing operable to be coupled with a center console of the aircraft;
a handle fixedly attached to the housing and arranged to be gripped by a human hand having a thumb and a plurality of fingers;
a rotatable trackball situated on the handle at a location to be turned by the thumb of the human hand gripped on the handle to effect movement of the cursor on the display; and
a trigger situated on the handle at a location to be depressed by one of the fingers of the human hand gripped on the handle to perform a select operation based on the position of the cursor.

9. The control device of claim 9, wherein the trackball is operable to be depressed to perform a select operation based on the position of the cursor.

10. The device of claim 9, wherein the handle has upper and lower surfaces, the trackball is situated on the upper surface, and the trigger is situated on the lower surface.

11. The device of claim 11, further including at least one switch situated on the upper surface and operable to switch the content of the display.

12. The device of claim 9, further including a plurality of switches on the handle each operable to be functioned to present different content on the display.

13. An integrated avionics system for an aircraft, comprising:
a display operable for mounting within the aircraft and for presenting at least one movable cursor; and
a control device associated with the display, the control device including—
a housing operable to be coupled with a center console of the aircraft,
a handle fixedly attached to the housing and having upper and lower surfaces, and
a rotatable trackball situated on the upper surface of the handle and operable to be actuated to effect movement of the cursor on the display.

14. The system of claim 13, further including a trigger situated on the lower surface of the handle and operable to be actuated to perform a select operation based on the position of the cursor.

15. The system of claim 13, further including at least one switch situated on the upper surface and operable to switch the content of the display.

16. The system of claim 13, further including a plurality of displays and at least one switch situated on the upper surface and operable to switch the content of at least one of the displays.

17. The system of claim 13, wherein the trackball is operable to be depressed to perform a select operation based on the position of the cursor.

18. The system of claim 13, the handle presenting a generally arched configuration

19. The system of claim 13, wherein the housing is operable to mount within the center console of the aircraft.
